(19) United States
(12) Patent Application Publication
(10) Pub. No.: US 2013/0020931 A1
(43) Pub. Date: Jan. 24, 2013

(54) WHITE LIGHT EMITTING DEVICE, AND DISPLAY APPARATUS AND ILLUMINATION APPARATUS USING THE SAME

(71) Applicants: Kun Yoo KO, Hwaesong (KR); Dong Hoon LEE, Suwon (KR); Kyu Ho JANG, Suwon (KR); Sun Yeol CHOI, Suwon (KR); Young Taek KIM, Hwaesong (KR)

(72) Inventors: Kun Yoo KO, Hwaesong (KR); Dong Hoon LEE, Suwon (KR); Kyu Ho JANG, Suwon (KR); Sun Yeol CHOI, Suwon (KR); Young Taek KIM, Hwaesong (KR)

(73) Assignee: SAMSUNG ELECTRONICS CO., LTD., Suwon-si (KR)

(21) Appl. No.: 13/552,123

(22) Filed: Jul. 18, 2012

(30) Foreign Application Priority Data
Jul. 18, 2011 (KR) 10-2011-0070985

(51) Int. Cl. H05B 33/14

(52) U.S. Cl. 313/503

(57) ABSTRACT

A white light emitting device includes a blue light emitting diode (LED) emitting blue light, a yellow phosphor excited by the blue light to emit yellow light, and selected from the group consisting of Y₃Al₅O₁₂ and Lu₃Al₅O₁₂, and a red phosphor and a green phosphor excited by the blue light to emit red light and green light, wherein white light obtained from a mixture of the blue light and excited light corresponds to a region defined by coordinate points of (0.28, 0.28), (0.24, 0.20), (0.26, 0.19), and (0.30, 0.27) in a CIE 1931 color coordinate system.

### CROSS-REFERENCE TO RELATED APPLICATIONS

This application claims the priority of Korean Patent Application No. 2011-0070985 filed on Jul. 18, 2011, in the Korean Intellectual Property Office, the disclosure of which is incorporated herein by reference.

### BACKGROUND OF THE INVENTION

1. Field of the Invention

The present invention relates to a white light emitting device and, more particularly, to a white light emitting device providing white light having excellent characteristics, and a display apparatus and an illumination apparatus using the same.

2. Description of the Related Art

In general, a phosphor material for converting a wavelength of light is used as a material for converting a particular wavelength of light from various light sources into a desired wavelength of light. In particular, among various light sources, a light emitting diode, driven with low power consumption and having excellent luminous efficiency, has been advantageously applied to LCD backlighting, vehicle illumination, and household illumination apparatuses, so recently, a phosphor material has come to prominence as a core technology in fabricating a white light emitting device.

In general, a white light emitting device is fabricated by applying one or more types of phosphor (e.g., red, yellow, or green) to a blue or ultraviolet LED chip. Color characteristics of light emitted therefrom may greatly vary according to the types of phosphors and combinations thereof.

Namely, an excellent color gamut can be expected when two or more types of phosphors, e.g., a red phosphor and one or more different phosphors, are combined, rather than when a single phosphor (e.g., a yellow phosphor) is used. In this case, however, efficiency is lowered and a luminosity factor is degraded in comparison to the general use of the yellow phosphor alone.

Also, since the white light emitting device using an LED is exposed to high temperature conditions, temperature stability and reliability of used phosphors are considered to be important issues. Temperature stability may be crucial in a high power usage condition. Thus, appropriate selection of types of phosphors in consideration of emitted light is required.

### SUMMARY OF THE INVENTION

An aspect of the present invention provides a white light emitting device capable of maintaining color characteristics such as a luminosity factor at a desired level along with having an excellent color gamut.

Another aspect of the present invention provides a display apparatus and an illumination apparatus using the white light emitting device.

According to an aspect of the present invention, there is provided a white light emitting device including: a blue light emitting diode (LED) emitting blue light; at least one yellow phosphor excited by the blue light to emit yellow light, and selected from the group consisting of Y₃Al₅O₁₂ and Lu₃Al₅O₁₂; and a red phosphor excited by the blue light to emit red light, wherein white light obtained from a mixture of the blue light and excited light corresponds to a region defined by coordinate points of (0.28, 0.28), (0.24 0.20), (0.26, 0.19), and (0.30, 0.27) in a CIE 1931 color coordinate system.

The yellow phosphor may include Y₃Al₅O₁₂. In a spectrum of the white light, a maximum peak wavelength, excluding a peak of blue light, may range from 550 nm to 560 nm.

In the spectrum of the white light, when a peak intensity of the blue light is 1, a relative intensity at 630 nm may range from 0.0698 to 0.2124.

In an example, a green phosphor may be used as an additional phosphor along with the red phosphor. In this case, in the spectrum of the white light, when a peak intensity of the blue light is 1, a relative intensity at 490 nm may range from 0.0744 to 0.1006.

In a different embodiment, the yellow phosphor may include Lu₃Al₅O₁₂. In this case, in the spectrum of the white light, a maximum peak wavelength, excluding the peak of blue light, may range from 535 nm to 545 nm.

When a peak intensity of the blue light is 1 in the spectrum of the white light, a relative intensity at 630 nm may range from 0.0889 to 0.2379.

A green phosphor may be used as an additional phosphor, along with the red phosphor. In this case, in the spectrum of the white light, when a peak intensity of the blue light is 1, a relative intensity at 490 nm may range from 0.0831 to 0.161.

According to another aspect of the present invention, there is provided a white light emitting device including: a blue light emitting diode (LED) emitting blue light; and a yellow phosphor expressed by La₃Si₆N₁₁, wherein white light obtained from a mixture of the blue light and excited light corresponds to a region defined by coordinate points of (0.28, 0.28), (0.24 0.20), (0.26, 0.19), and (0.30, 0.27) in a CIE 1931 color coordinate system.

In this case, in a spectrum of the white light, a maximum peak wavelength, excluding the peak of blue light, may range from 532 nm to 542 nm.

The additional phosphor may be a red phosphor. In this case, in the spectrum of the white light, when a peak intensity of the blue light is 1, a relative intensity at 630 nm may range from 0.0648 to 0.1913.

Apart from the red phosphor, or along with the red phosphor, a green phosphor may be used as the additional phosphor. In this case, when a peak intensity of the blue light is 1 in the spectrum of the white light, a relative intensity at 630 nm may range from 0.0698 to 0.2124.

A dominant wavelength band of the blue light emitted from the blue LED may range from 435 nm to 465 nm. A color gamut of the white light may be 97% or more over an sRGB area.

A luminosity factor of the white light may be greater than 225 lm/W. In particular, a value of the luminosity factor of the white light, which has been reduced by less than 5% from a luminosity factor of the white light when the yellow phosphor is present, may be maintained.

The red phosphor may be at least one of AAlSiNₓ:Eu (1≦x≦5) and A₂Si₅N₈:Eu, wherein the A may be at least one of Ba, Sr, Ca, and Mg.

The green phosphor may include β-SiAlON:Eu or L₃M₅O₁₂:Ce, wherein the L may be at least one of Lu, Yb, and Tb, and the M may be at least one of Al and Ga.

According to another aspect of the present invention, there is provided a display apparatus including: a light emitting diode (LED) light source module; and an image display panel, to which light from the LED light source module is irradiated, displaying an image, wherein the LED light source module includes a circuit board and at least one foregoing white light emitting device mounted on the circuit board.

According to another aspect of the present invention, there is provided an illumination apparatus including: a light emitting diode (LED) light source module and a diffusion unit disposed above the LED light source module and uniformly diffusing light made incident from the LED light source module, wherein the LED light source module includes a circuit board and at least one foregoing white light emitting device mounted on the circuit board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph showing a spectrum of white light emitted from a white light emitting device, explaining a principle of the present invention;

FIG. 2 is a CIE 1931 color coordinate system of white light emitted from the white light emitting device, explaining a principle of the present invention;

FIG. 3 is a graph showing a target color coordinate region of white light emitted from the white light emitting device;

FIG. 4 is a graph showing a spectrum of white light emitted from the white light emitting device according to an Experimental Example (Y₃Al₅O₁₂) in relation to an aspect of the present invention;

FIG. 5 is a graph showing a spectrum of white light emitted from the white light emitting device according to another Experimental Example (Lu₃Al₅O₁₂) in relation to an aspect of the present invention;

FIG. 6 is a graph showing a spectrum of white light emitted from the white light emitting device according to another Experimental Example (La₃Si₆N₁₁) in relation to an aspect of the present invention;

FIG. 7 is a graph showing a spectrum of white light emitted from a white light emitting device according to Comparative Example 4;

FIG. 8 is a graph showing color coordinates of white light emitted from the white light emitting device according to Comparative Example 4;

FIG. 9 is a graph showing CIE 1931 color coordinate system representing a color gamut of the white light emitting device according to Comparative Example 4;

FIG. 10 is a graph showing a comparison of temperature stability between various Embodiments of the present invention and Comparative Example (Comparative Example 5);

FIGS. 11 through 14 are schematic views showing white light emitting devices according to various embodiments of the present invention.

FIGS. 15(a) and 15(b) show various types of backlight units that may be employed in a display apparatus according to an embodiment of the present invention;

FIG. 16 is an exploded perspective view of an LCD display apparatus according to an embodiment of the present invention; and

FIGS. 17 through 19 are cross-sectional views of various types of backlight units that may be employed in a display apparatus according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

A white light emitting device according to an aspect of the present invention includes a blue light emitting diode (LED) emitting blue light, at least one yellow phosphor excited by the blue light to emit yellow light, and selected from the group consisting of Y₃Al₅O₁₂ and Lu₃Al₅O₁₂, and a red phosphor excited by the blue light to emit red light.

Here, the red phosphor along with the yellow phosphor selected together therewith are mixed such that white light obtained from a mixture of the blue light and excited light corresponds to a region defined by coordinate points (0.28, 0.28), (0.24, 0.20), (0.26, 0.19), and (0.30, 0.27) in the CI3 1931 color coordinate system.

Through the mixture of phosphors, a color gamut of the white light can be drastically enhanced in comparison to the case of using a yellow phosphor alone.

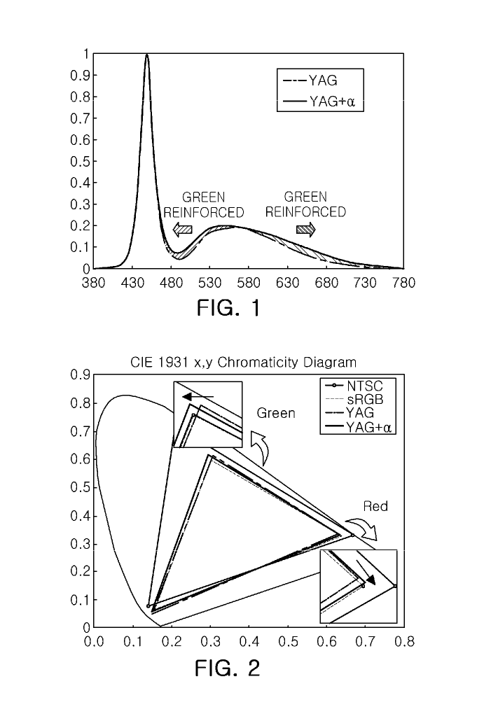

For example, as shown in FIG. 1, in comparison to a white light spectrum in the case of using a yellow phosphor of Y₃Al₅O₁₂ (YAG) in a blue LED chip, a green light region and/or a red light region can be reinforced by mixing a certain amount of the green and/or red phosphors within the range in which the color coordinate conditions are maintained.

In this manner, a color gamut can be significantly enhanced. Namely, with reference to the CIE 1931 color coordinate regions as shown in FIG. 2, a color gamut of YAG is 92.99%, which is very low, in comparison to an sRGB area, but when the red or green phosphor is injected (or inserted) along with YAG (YAG+α), the color gamut region can be enlarged as indicated in an arrow direction.

In detail, the white light emitting device according to an embodiment of the present invention is expected to achieve a high color gamut of 95% or more, and preferably, 97% or more, over the sRGB area.

Also, efficiency cannot be greatly degraded in comparison to the case of using the yellow phosphor alone. In particular, a luminosity factor of white light can be maintained at a desired level. Preferably, a luminosity factor of more than 225 lm/W can be maintained. In another aspect, a value of the luminosity factor of white light, which has been reduced by less than 5% from a luminosity factor of white light when the yellow phosphor is present, can be maintained.

A dominant wavelength band of blue light emitted from the blue LED may range from 435 nm to 465 nm. The red phosphor may be at least one of AAlSiNₓ:Eu (1≦x≦5) and A₂Si₅N₈:Eu, and here A may be at least one of Ba, Sr, Ca, and Mg. The green phosphor may include β-SiAlON:Eu or L₃M₅O₁₂:Ce, and here, L may be at least one of Lu, Yb, and Tb, and M may be at least one of Al and Ga.

The conditions of the phosphor mixture employed in the white light emitting device according to an embodiment of the present invention may be specifically defined by the spectrum characteristics of white light according to types of the phosphors in use.

In an embodiment, the yellow phosphor includes Y₃Al₅O₁₂. In this case, in the spectrum of white light, a maximum peak wavelength, excluding the peak of blue light, may range from 550 nm to 560 nm.

In this case, when the peak intensity of blue light is 1 in the spectrum of white light, a relatively intensity at 630 nm may range from 0.0698 to 0.2124.

Also, along with the red phosphor, a green phosphor may be used as an additional phosphor. In this case, when the peak intensity of blue light is 1 in the spectrum of white light, a relative intensity at 490 nm may range from 0.0744 to 0.1006.

In another embodiment, the yellow phosphor includes Lu₃Al₅O₁₂. In this case, in the spectrum of white light, a maximum peak wavelength, excluding the peak of blue light, may range from 535 nm to 545 nm.

In this case, when the peak intensity of blue light is 1 in the spectrum of white light, a relative intensity at 630 nm may range from 0.0889 to 0.2379.

Also, along with the red phosphor, a green phosphor may be used as an additional phosphor. In this case, when the peak intensity of blue light is 1 in the spectrum of white light, a relative intensity at 490 nm may range from 0.0831 to 0.161.

In another embodiment, a scheme of using La₃Si₆N₁₁ as the yellow phosphor is provided. Namely, a white light emitting device including a blue LED emitting blue light and a yellow phosphor, as La₃Si₆N₁₁, excited by the blue light to emit yellow light, and having characteristics that white light obtained by mixing the blue light and the excited light corresponds to a region defined by coordinate points (0.28, 0.28), (0.24, 0.20), (0.26, 0.19), and (0.30, 0.27) in the CIE 1931 color coordinate system is provided.

In this case, in the spectrum of white light, a maximum peak wavelength, excluding the peak of blue light, ranges from 532 nm to 542 nm.

For example, an additional phosphor may be a red phosphor. In this case, in the spectrum of white light, when the peak intensity of blue light is 1, a relative intensity at 630 nm may range from 0.0648 to 0.1913.

In another example, an additional phosphor may be a green phosphor used together with the red phosphor or used alone. In this case, in the spectrum of white light, when a peak intensity of blue light is 1, a relative intensity at 630 nm may range from 0.0698 to 0.2124.

Operations and effects of the present invention will be described in detail through embodiments of the present invention.

### Embodiments 1A and 1B

In Embodiments 1A and 1B, phosphor mixtures were prepared under the conditions shown in Table 1 below and applied to a blue LED having a wavelength of 455 nm, and a white light emitting device having a structure as shown in FIG. 11 was prepared.

### Comparative Examples 1A and 1B

In Comparative Examples 1A and 1B, phosphor mixtures were applied to a blue LED having a wavelength of 455 nm in a similar manner to that of the former embodiments, and a white light emitting device having a structure illustrated in FIG. 11 was prepared. Here, in Comparative Examples 1A and 1B, phosphors prepared under the conditions shown in Table 1 were applied.

TABLE 1

| Classification | Y₃Al₅O₁₂ | CaAlSiN | Lu₃Al₅O₁₂ |
|---|---|---|---|
| Embodiment 1A | 38.0 wt % | 15.2 wt % | 46.8 wt % |
| Embodiment 1B | 85.7 wt % | 14.3 wt % | — |
| Comparative | 100 wt % | — | — |
| Example 1A | | | |
| Comparative | 44.8 wt % | — | 55.2 wt % |
| Example 1B | | | |

Each color gamut across the sRGB area, along with color coordinates of white light emitted from the white light emitting device according to Embodiments 1A and 1B and Comparative Examples 1A and 1B, was measured as shown in Table 2 below.

TABLE 2

| | | | Color gamut | Luminosity (lm/W) |
|---|---|---|---|---|
| | Color coordinates | | (over sRGB | (Increase/ |
| Classification | Cx | Cy | area) | decrease rate, %) |
| Embodiment 1A | 0.270 | 0.243 | 99.0% | 238.6 (−2.8) |
| Embodiment 1B | 0.272 | 0.221 | 97.0% | 236.5 (−3.7) |
| Comparative | 0.267 | 0.227 | 92.99% | 245.6 (reference) |
| Example 1A | | | | |
| Comparative | 0.256 | 0.236 | 96.9% | |
| Example 1B | | | | |

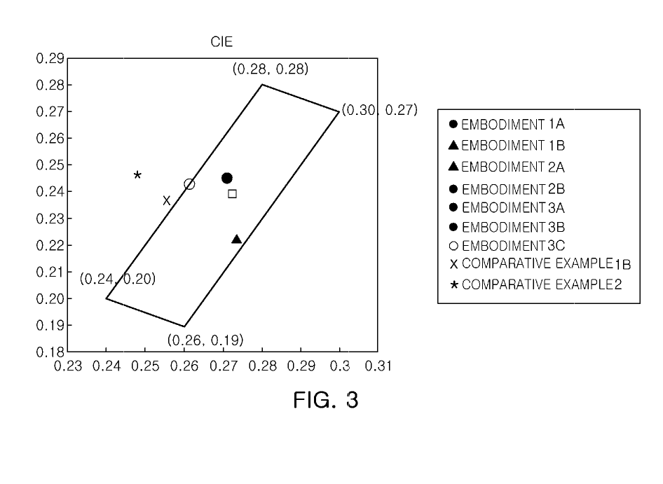

It was confirmed that the color coordinates of Comparative Example 1B did not correspond to a target color coordinate region of the present invention, while those of Embodiments 1A and 1B corresponded to the target color coordinate region (See FIG. 3), and in particular, the color gamuts of the white light emitting devices according to Embodiments 1A and 1B were 97% and 99% respectively, namely, very high. In the case of Comparative Example 1, the color coordinates corresponded to the target color coordinate region, but a color gamut thereof was less than 93%.

Meanwhile, luminosity factors of Embodiments 1A and 1B were 238.6 and 236.5, i.e., relatively high, respectively, and in comparison to Comparative Example 1A which used only YAG phosphors, the luminosity factors of Embodiments 1A and 1B were maintained at a not greatly lowered level, i.e., a level reduced by about 2.8% and 3.7%, respectively.

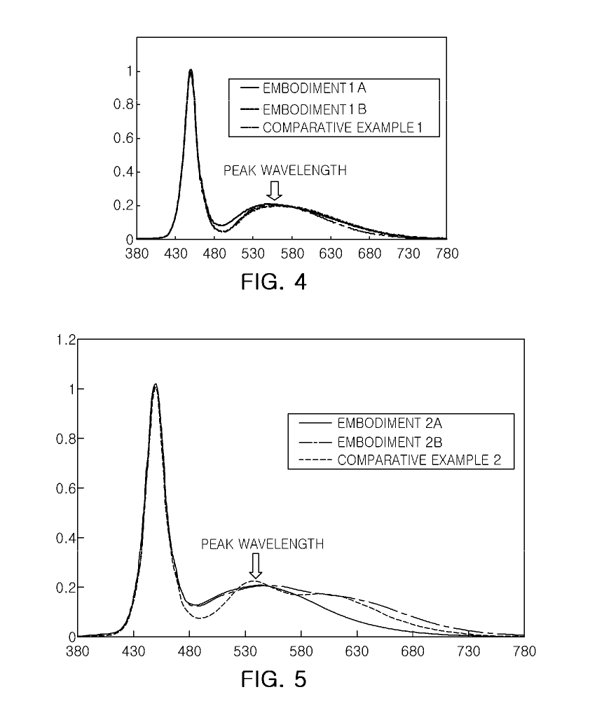

Spectrums of white light emitted from the white light emitting devices according to Embodiments 1A and 1B and Comparative Example 1A are illustrated in FIG. 4.

As shown in FIG. 4, in Embodiments 1A and 1B and Comparative Example 1A using YAG, a maximum peak wavelength, excluding a peak of blue light, ranged from 550 nm to 560 nm in the spectrum of white light.

It was confirmed that, in comparison to the spectrum of Comparative Example 1A in which only YAG was used, in the case of Embodiment 1B in which an additional phosphor was a red phosphor, a red region was reinforced, and in the case of Embodiment 1A in which an additional phosphor was a mixture of the red phosphor and the green phosphor, both the red and green regions were reinforced in the spectrum of white light.

In detail, in the case of Embodiment 1B, when a peak intensity of blue light was 1, a relative intensity at 630 nm was about 0.12, satisfying a range of 0.0698 to 0.2124. In the case of Embodiment 1A, a relative intensity even at 490 nm was about 0.09, satisfying a range of 0.0744 to 0.1006.

In this manner, the color gamuts were enhanced by reinforcing the red and green regions as described above.

### Embodiments 2A and 2B

In Embodiments 1A and 1B, phosphor mixtures were prepared under the conditions shown in Table 3 below and applied to a blue LED having a wavelength of 455 nm, and a white light emitting device having a structure as shown in FIG. 11 was prepared.

### Comparative Examples 2A and 2B

In Comparative Examples 2A and 2B, phosphor mixtures were applied to a blue LED having a wavelength of 455 nm in a similar manner to that of the former embodiments, and a white light emitting device having a structure illustrated in FIG. 11 was prepared. Here, in Comparative Examples 2A and 2B, phosphors prepared under the conditions shown of Table 3 were applied.

TABLE 3

| Classification | Lu₃Al₅O₁₂ | CaAlSiN | (Sr,Ba)₂SiO₄ |
|---|---|---|---|
| Embodiment 2A | 28.9 wt % | 52.3 wt % | 18.8 wt % |
| Embodiment 2B | 73.3 wt % | 26.7 wt % | — |
| Comparative | 100 wt % | — | — |
| Example 2A | | | |
| Comparative | 79.2% | — | 20.8 wt % |
| Example 2B | | | |

Each color gamut across the sRGB area, along with color coordinates of white light emitted from the white light emitting device according to Embodiments 2A and 2B and Comparative Examples 2A and 2B, was measured as shown in Table 4 below.

TABLE 4

| | | | Color gamut | Luminosity (lm/W) |
|---|---|---|---|---|
| | Color coordinates | | (over sRGB | (Increase/ |
| Classification | Cx | Cy | area) | decrease rate, %) |
| Embodiment 1A | 0.271 | 0.239 | 98.3% | 238.8 (+0.4) |
| Embodiment 1B | 0.270 | 0.243 | 97.9% | 226.5 (−4.7) |
| Comparative | 0.246 | 0.247 | 92.9% | 237.7 (reference) |
| Example 1A | | | | |
| Comparative | 0.256 | 0.260 | 9.29% | |
| Example 1B | | | | |

It was confirmed that color coordinates of both of Comparative Examples 2A and 2B did not correspond to the target color coordinate region of the present invention, while those of Embodiments 2A and 2B corresponded to the target color coordinate region (See FIG. 3), and in particular, the color gamuts of the white light emitting device according to Embodiments 2A and 2B were respectively maintained to be 98.3% and 97.9%, namely, very high.

Meanwhile, luminosity factors of Embodiments 2A and 2B were 238.8 and 226.5, i.e., relatively high, respectively, and in comparison to Comparative Example 2A which used only yellow phosphor of Lu₃Al₅O₁₂, the luminosity factors of Embodiments 2A and 2B were maintained at a similar level, i.e., a level increased by about 0.4% and reduced by about 4.7%, respectively.

Spectrums of white light emitted from the white light emitting devices according to Embodiments 2A and 2B and Comparative Example 2A are illustrated in FIG. 5.

As shown in FIG. 5, in Embodiments 2A and 2B and Comparative Example 2A using YAG, a maximum peak wavelength, excluding a peak of blue light, ranged from 535 nm to 545 nm in the spectrum of white light.

It was confirmed that, in comparison to the spectrum of Comparative Example 2A in which only a yellow phosphor of Lu₃Al₅O₁₂ was used, in the case of Embodiment 2B in which an additional phosphor was a red phosphor, a red region was reinforced, and in the case of Embodiment 2A in which an additional phosphor was a mixture of the red phosphor and the green phosphor, both the red and green regions were reinforced in the spectrum of white light.

In detail, in the case of Embodiment 2B, when a peak intensity of blue light was 1, a relative intensity at 630 nm was about 0.15, satisfying a range of 0.0889 to 0.2379. In the case of Embodiment 2A, a relative intensity even at 490 nm was about 0.14, satisfying a range of 0.0831 to 0.161.

In this manner, the color gamuts were enhanced by reinforcing the red and green regions as described above.

### Embodiments 3A to 3D

In Embodiments 3A to 3D, phosphor mixtures were prepared under the conditions shown in Table 5 below and applied to a blue LED having a wavelength of 455 nm, and a white light emitting device having a structure as shown in FIG. 11 was prepared.

TABLE 5

| Classification | La₃Si₆N₁₁ | CaAlSiN | (Sr,Ba)₂SiO₄ |
|---|---|---|---|
| Embodiment 3A | 74.1 wt % | 14.8 wt % | 11.1 wt % |
| Embodiment 3B | 90 wt % | 10 wt % | — |
| Embodiment 3C | 100 wt % | — | — |
| Embodiment 3D | 64.1 wt % | — | 36.9 wt % |

Each color gamut across the sRGB area, along with color coordinates of white light emitted from the white light emitting device according to Embodiments 3A to 3D, was measured as shown in Table 4 below.

TABLE 6

| | | | Color gamut | Luminosity (lm/W) |
|---|---|---|---|---|
| | Color coordinates | | (over sRGB | (Increase/ |
| Classification | Cx | Cy | area) | decrease rate, %) |
| Embodiment 3A | 0.270 | 0.243 | 99.4% | 245.5 (−4.4) |
| Embodiment 3B | 0.270 | 0.243 | 98.2% | 244.2 (−4.8) |
| Embodiment 3C | 0.262 | 0.242 | 98.2% | 256.7 (reference) |
| Embodiment 3D | 0.270 | 0.258 | 96.11% | |

It was confirmed that color coordinates of all of Embodiments 3A to 3D corresponded to the target color coordinate region (See FIG. 3), and in particular, the color gamuts of the white light emitting device according to Embodiments 3A to 3D were respectively maintained to be 99.4%, 98.2%, 98.2%, and 96.11%, namely, very high. Luminosity factors of Embodiments 3A to 3C were 245.5, 244.2, and 256.7, i.e., relatively high, respectively, and in comparison to Embodiment 3C which used only yellow phosphor of La₃Si₆N₁₁, the luminosity factors of Embodiments 3A and 3B were maintained at a level reduced by about 4.4% and 4.8%, respectively.

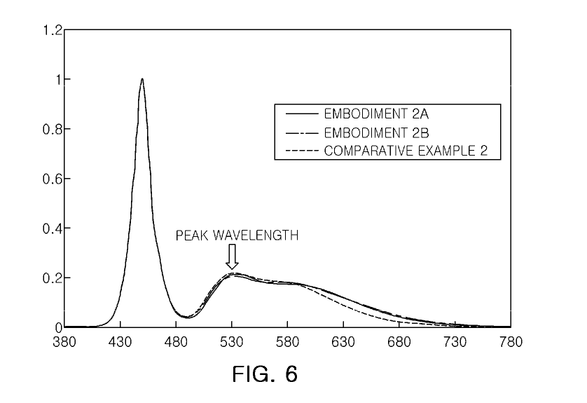

Spectrums of white light emitted from the white light emitting devices according to Embodiments 3A to 3C are illustrated in FIG. 6.

As shown in FIG. 6, a maximum peak wavelength, excluding a peak of blue light, ranged from 532 nm to 542 nm.

It was confirmed that, in comparison to the spectrum of Embodiment 3C in which only a yellow phosphor of La₃Si₆N₁₁ was used, in the case of Embodiment 3B in which an additional phosphor was a red phosphor, a red region was reinforced, and in the case of Embodiment 3A in which an additional phosphor was a mixture of the red phosphor and the green phosphor, both the red and green regions were reinforced.

In detail, in the case of Embodiment 3B, when a peak intensity of blue light was 1, a relative intensity at 630 nm satisfied a range of 0.0648 to 0.1913. In the case of Embodiment 3A, a relative intensity even at 490 nm satisfied a range of 0.0361 to 0.0458.

In this manner, the color gamuts were enhanced by reinforcing the red and green regions as described above.

Under conditions of the present invention, desired color gamuts can be obtained when they are out of the color coordinate region although the wavelength conditions of the spectrum are satisfied. This will be described with reference to Comparative Example 4 as follows.

### Comparative Example 4

In Comparative Example 4, a phosphor mixture was prepared and applied to a blue LED having a wavelength of 455 nm, and a white light emitting device having a structure illustrated in FIG. 11 was prepared.

The phosphor mixture of Comparative Example 4 was prepared by mixing 53 wt % of a yellow phosphor of La₃Si₆N₁₁, 38 wt % of a red phosphor of CaAlSiN, and 9 wt % of a green phosphor of (Sr,Ba)₂SiO₄.

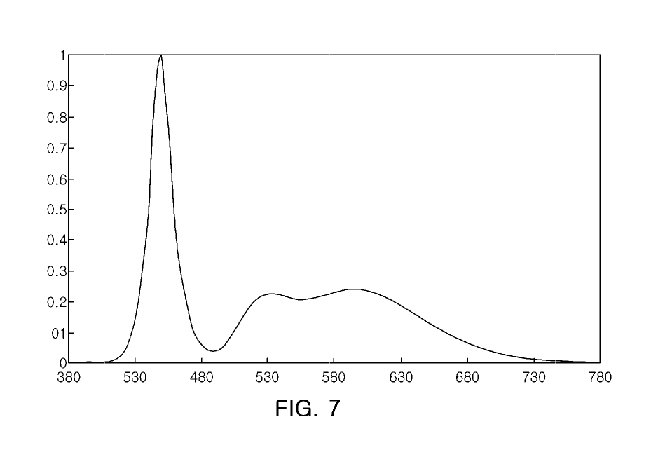

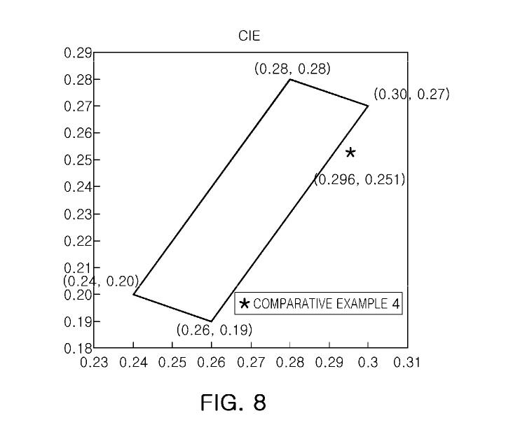

Spectrums along with color coordinates emitted from the white light emitting device according to Comparative Example 4 were measured. The results are shown in FIG. 7 (spectrum) and FIG. 8 (color coordinates), respectively. Color coordinates along with spectrum characteristics were measured and shown in Table 7 below.

TABLE 7

| | | | Relative | | |
|---|---|---|---|---|---|
| | | | intensity | | |
| | | | (peak | Relative | Relative |
| | Color coordinate | | wavelength: | intensity | intensity |
| Classification | Cx | Cy | 540 nm) | (630 nm) | (490 nm) |
| Comparative | 0.296 | 0.251 | 0.1992 | 0.1791 | 0.0415 |
| Example 4 | | | | | |

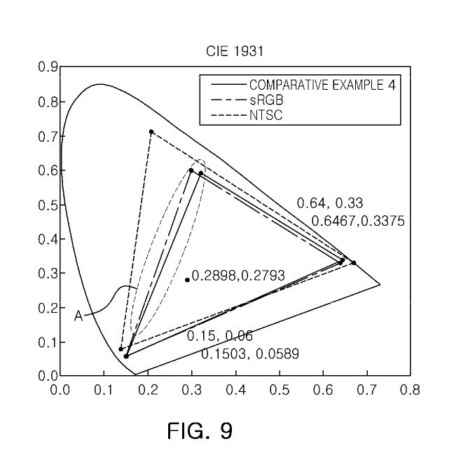

As for color coordinates of white light, final coordinates thereof may be finally changed by a change in a spectrum after passing through an LCD panel, and when the color coordinates are outside of the range proposed in the present invention, a red or green component is increased to result in a reduction in a color gamut region of a particular portion. In Comparative Example 4, as shown in FIG. 9, a green region denoted by ‘A’ is relatively reduced, and as a result, a color gamut may be reduced to be less than 97% over the sRGB area.

In this manner, the color coordinate region of white light may be required to satisfy a region defined by coordinate points of (0.28, 0.28), (0.24 0.20), (0.26, 0.19), and (0.30, 0.27) in the CIE 1931 color coordinate system.

### Comparative Example 5

In Comparative Example 5, a phosphor mixture was prepared and applied to a blue LED having a wavelength of 455 nm, and a white light emitting device having a structure illustrated in FIG. 11 was prepared.

The phosphor mixture of Comparative Example 4 was prepared by mixing a yellow phosphor, a red phosphor, and a green phosphor, i.e., silicate-based phosphors.

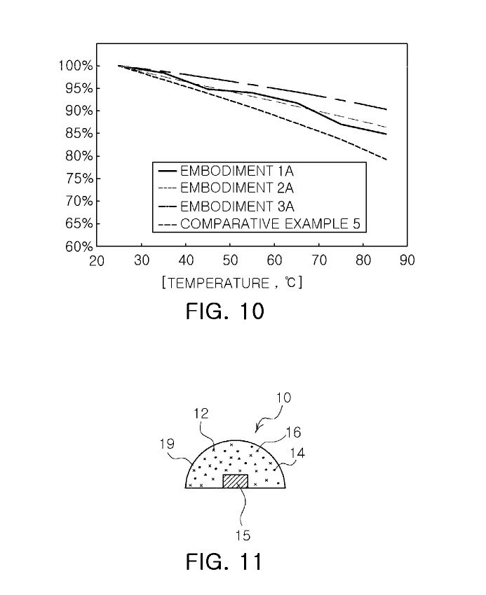

Temperature stability of each the white light emitting device according to Embodiments 1A, 2A, and 3A, and Comparative Example 5 was evaluated. The results are shown as a graph in FIG. 10.

As shown in FIG. 10, in comparison to Comparative Example 5, a mixture of silicate-based phosphors, temperature stability of Embodiments 1A and 2A were superior, and Embodiment 3A employing yellow phosphor of La₃Si₆N₁₁ exhibits the most excellent temperature stability.

The white light emitting device proposed in the present invention may be implemented in various forms and may be applied to various application forms such as a display apparatus and an illumination apparatus.

Hereinafter, various examples and applications forms of the white light emitting device according to embodiments of the present invention will be described with reference to the accompanying drawings.

FIG. 11 is a schematic view showing a white light emitting device according to an embodiment of the present invention.

As shown in FIG. 11, the white light emitting device 10 according to the present embodiment includes a blue LED chip 15 and a resin packaging unit 19 packaging the blue LED chip 15 and having an upwardly convex lens shape.

The resin packaging unit 19 employed in the present embodiment is illustrated to have a hemispherical lens shape to secure a wide angle of beam spread. The blue LED chip 15 may be directly mounted on a circuit board. The resin packaging unit 19 may be made of a silicon resin, an epoxy resin, or a combination thereof. As mentioned above, at least one of a red phosphor 14 and a green phosphor 16 may be dispersed along with a yellow phosphor 12 within the resin packaging unit 19.

A dominant wavelength band of blue light emitted from the blue LED chip 15 may range from 435 nm to 465 nm. The yellow phosphor 12 may be selected from the group consisting of Y₃Al₅O₁₂, Lu₃Al₅O₁₂, and La₃Si₆Nₙ. Also, at least one additional phosphor of the red phosphor 14 and the green phosphor 16 may be included (in the present embodiment, both of the red and green phosphors are included).

The red phosphor 14 may be at least one of AAlSiNₓ:Eu (1≦x≦5) and A₂Si₅N₈:Eu, and here, A may be at least one of Ba, Sr, Ca, and Mg. The green phosphor 16 may include β-SiAlON:Eu or L₃M₅O₁₂:Ce, and here, L may be at least one of Lu, Yb, and Tb and M may be at least one of Al and Ga.

The three types of phosphors may be mixed at an appropriate mix proportion such that white light obtained when mixed with blue light corresponds to a region defined by coordinate points of (0.28, 0.28), (0.24 0.20), (0.26, 0.19), and (0.30, 0.27) in the CIE 1931 color coordinate system.

A color gamut of white light may be 95% over an sRGB area, and preferably, 97% or more. A luminosity factor of white light may be more than 225 lm/W. Preferably, a value of the luminosity factor of white light, reduced by less than 5% from a luminosity factor of white light when the yellow phosphor is present, is maintained.

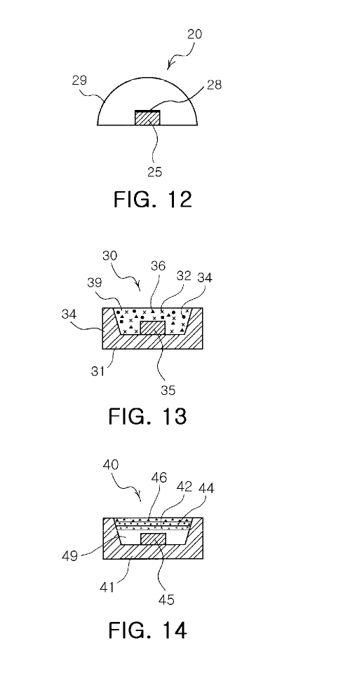

Similar to that of the former embodiment, a white light emitting device 20 illustrated in FIG. 12 includes a blue LED chip 25 and a resin packaging unit 29 packaging the blue LED chip 25 and having an upwardly convex lens shape, but it is illustrated that a wavelength conversion unit 28 is directly provided to an upper surface of the blue LED chip 25. The wavelength conversion unit 28 is provided in the form of a mixture of a yellow phosphor and a red and/or green phosphor.

A white light emitting device 30 illustrated in FIG. 13 includes a package main body 31 having a reflective cup formed in the center thereof, a blue LED chip 35 mounted on a bottom portion of the reflective cup, and a transparent resin packaging unit 39 encapsulating the blue LED chip 35 within the reflective cup.

The resin packaging unit 39 may be made of a silicon resin, an epoxy resin, or a combination thereof. In the present embodiment, the resin packaging unit 39 may be provided such that a yellow phosphor 32 and red and/or green phosphor 34, 36 are dispersed within the resin packaging unit 39.

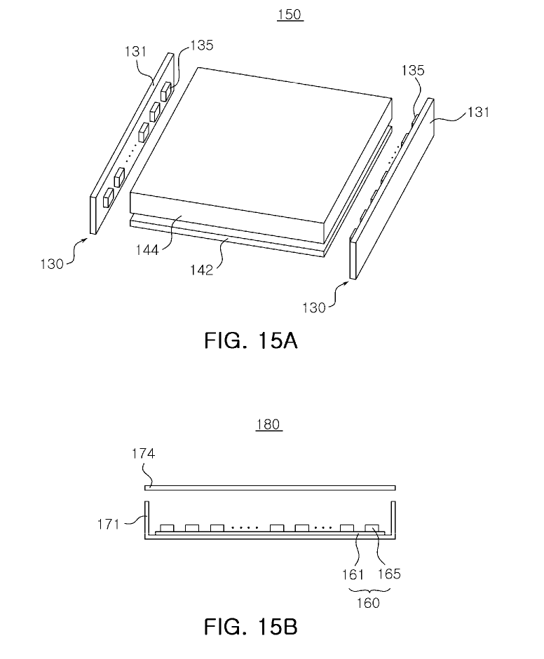

In embodiments illustrated in FIGS. 14 and 15, a structure in which powder of two types or three types of phosphors is mixedly dispersed in a single resin packaging unit region is illustrated, but the present invention is not limited thereto and the structure may be variably modified and implemented. At least one type of phosphor may be provided to a different layer structure and separately implemented.

Similar to those of the former embodiments, the white light emitting device 40 includes a package main body in which a reflective cup is formed in the center thereof, a blue LED 45 mounted on a bottom portion of the reflective cup, and a transparent resin packaging unit 49 encapsulating the blue LED 45 within the reflective cup.

Resin layers containing different phosphors are provided on the resin packaging unit 49. Namely, a wavelength conversion unit may be configured to include a first resin layer containing a red phosphor 44, a second resin layer containing the yellow phosphor 42, and a third resin layer 46 containing the green phosphor.

In this manner, white light obtained through the mixture of the phosphors proposed in the present invention can have a high color rendering index (CRI).

FIGS. 15(a) and 15(b) show various types of backlight units that may be employed in a display apparatus according to an embodiment of the present invention.

With reference to FIG. 15(a), an edge type backlight unit 150 is illustrated as an example of a backlight unit in which a white light emitting device according to an embodiment of the present invention can be applicable as a light source.

The edge type backlight unit 150 according to the present embodiment may include a light guide plate 144 and LED light source modules 130 provided at both sides of the light guide plate 144.

In the present embodiment, it is illustrated that the LED light source modules 130 are provided at both opposed sides of the light guide plate 144, but the present invention is not limited thereto and the LED light source module 130 may be provided only at one side of the light guide plate 144, or alternatively, an additional LED light source module 130 may be provided on a different side of the light guide plate 144.

As shown in FIG. 15(a), a reflective plate 142 may be additionally provided under the light guide plate 144. The LED light source modules 130 employed in the present embodiment may include a printed circuit board (PCB) 131 and a plurality of LED light sources 135 mounted on an upper surface of the PCB 131. The LED light source 135 may be applied to the white light emitting device using the combination of the phosphors as described above.

With reference to FIG. 15(b), a direct type backlight unit 180 is illustrated as an example of a different type of backlight unit.

The direct type backlight unit 180 according to the present embodiment may include a light diffusion plate 174 and LED light source modules 160 arranged under the light diffusion plate 174.

The backlight unit 180 illustrated in FIG. 15(b) may include a bottom case 171 at a lower side of the light diffusion plate 174 in order to accommodate the light source modules.

The LED light source modules 160 employed in the present embodiment includes a PCB 161 and a plurality of LED light sources 165 mounted on an upper surface of the PCB 161. The plurality of LED light sources 165 may be white light emitting devices using the combination of the foregoing phosphors as a wavelength conversion material.

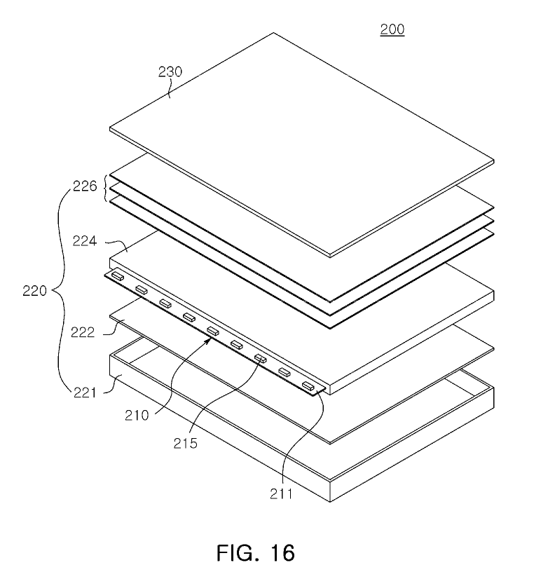

FIG. 16 is an exploded perspective view of a display apparatus according to an embodiment of the present invention.

A display apparatus 200 illustrated in FIG. 16 includes a backlight unit 220 and an image display panel 230. The backlight unit 220 includes a light guide plate 224 and a LED light source module 210 provided on at least one side of the light guide plate 224.

In the present embodiment, as illustrated, the backlight unit 220 may further include a bottom case 221 and a reflective plate 222 disposed under the light guide plate 224.

Also, according to demand for various optical characteristics, various types of optical sheets 226 such as a diffusion sheet, a prism sheet, a protective sheet, and the like, may be disposed between the light guide plate 224 and the liquid crystal panel 230.

The LED light source module 210 includes a PCB 211 provided on at least one side of the light guide plate 224 and a plurality of LED light sources 215 mounted on the PCB 211 and making light incident to the light guide plate 224. The plurality of LED light sources 215 may be the white light emitting device as described above. The plurality of LED light sources 215 employed in the present embodiment may be a side view-type light emitting device package in which sides thereof adjacent to a light emission surface are mounted.

In this manner, the foregoing phosphors are applied to the white light emitting devices having various mounting structures and applied to various types of LED light source modules providing white light. The foregoing light emitting device package or a light source module including the same may be applied to various types of display apparatuses or illumination apparatuses.

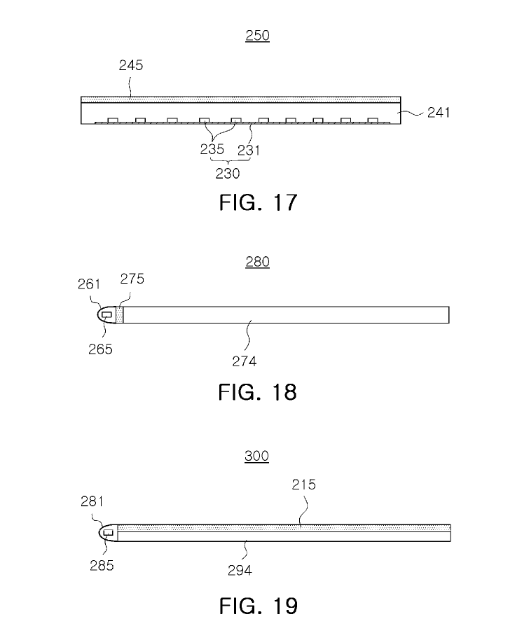

Besides the foregoing embodiments, phosphors may be disposed in a different element of a backlight unit, rather than being directly disposed in a package in which an LED is positioned, to convert light. This embodiment is illustrated in FIGS. 17 through 19.

First, as illustrated in FIG. 17, a direct type backlight unit 250 according to the present invention may include a phosphor film 245 and a LED light source module 230 disposed on a lower surface of the phosphor film 245.

The backlight unit 250 illustrated in FIG. 17 may include a bottom case 241 accommodating the light source module 230. In the present embodiment, the phosphor film 245 is disposed on an upper surface of the bottom case 241. At least a portion of light emitted from the light source module 230 may be wavelength-converted by the phosphor film 245. The phosphor film 245 may be fabricated as a separate film and applied, or may be integrally coupled to a light diffusion plate and provided.

Here, the LED light source module 230 may include a PCB 231 and a plurality of LED light sources 235 mounted on an upper surface of the PCB 231.

FIGS. 18 and 19 illustrate various edge-type backlight units which may be employed in a display apparatus according to an embodiment of the present invention.

An edge type backlight unit 280 illustrated in FIG. 18 may include a light guide plate 274 and an LED light source 265 provided on one side of the light guide plate 274. Light from the LED light source 265 may be guided to the interior of the light guide plate 274 by a reflective structure 261. In the present embodiment, a phosphor film 275 may be positioned between a lateral side of the light guide plate 274 and the LED light source 265.

An edge type backlight unit 300 illustrated in FIG. 19 may include a light guide plate 294 and an LED light source 285 and a reflective structure 281 provided at one side of the light guide plate 294. In the present embodiment, it is illustrated that a phosphor film 215 is applied to a light emitting surface of the light guide plate 294.

In this manner, it may be implemented such that the phosphor is applied to a different device such as a backlight unit, or the like, rather than being directly applied to an LED light source.

An illumination apparatus according to an embodiment of the present invention includes an LED light source module and a diffusion unit disposed at an upper portion of the LED light source module and uniformly diffusing light made incident from the LED light source module. The LED light source module includes a circuit board and at least one white light emitting device as described above mounted on the circuit board.

As set forth above, according to embodiments of the invention, since a phosphor having a particularly different color is additionally employed together with a yellow phosphor in a blue LED, an excellent color gamut can be obtained and a luminosity factor and efficiency cannot be greatly degraded. In addition, by employing a phosphor having excellent temperature stability, reliability of a white light emitting device can be enhanced and white light having an excellent color gamut while satisfying desired color coordinates characteristics can be provided.

In addition, by employing an LSN-based yellow phosphor, an excellent white light emitting device satisfying particular color coordinate conditions can be provided, and also, in this case, a high color gamut can be obtained by additionally employing a phosphor having a particular different color.

While the present invention has been shown and described in connection with the embodiments, it will be apparent to those skilled in the art that modifications and variations can be made without departing from the spirit and scope of the invention as defined by the appended claims.

1. A white light emitting device comprising:
a blue light emitting diode (LED) emitting blue light; at least one yellow phosphor excited by the blue light to emit yellow light, and selected from the group consisting of Y₃Al₅O₁₂ and Lu₃Al₅O₁₂; and
a red phosphor excited by the blue light to emit red light,
wherein white light obtained from a mixture of blue light and excited light corresponds to a region defined by coordinate points of (0.28, 0.28), (0.24 0.20), (0.26, 0.19), and (0.30, 0.27) in a CIE 1931 color coordinate system.

2. The white light emitting device of claim 1, wherein the yellow phosphor includes Y₃Al₅O₁₂, and in a spectrum of the white light, a maximum peak wavelength, excluding a peak of blue light, ranges from 550 nm to 560 nm.

3. The white light emitting device of claim 2, wherein, in the spectrum of the white light, when a peak intensity of the blue light is 1, a relative intensity at 630 nm ranges from 0.0698 to 0.2124.

4. The white light emitting device of claim 3, wherein the red phosphor is at least one of AAlSiNₓ:Eu (1≦x≦5) and A₂Si₅N₈:Eu, wherein the A is at least one of Ba, Sr, Ca, and Mg.

5. The white light emitting device of claim 3, further comprising a green phosphor emitting green light, wherein, in the spectrum of the white light, when a peak intensity of the blue light is 1, a relative intensity at 490 nm ranges from 0.0744 to 0.1006.

6. The white light emitting device of claim 5, wherein the green phosphor includes β-SiAlON:Eu or L₃M₅O₁₂:Ce, wherein L is at least one of Lu, Yb, and Tb, and the M is at least one of Al and Ga.

7. The white light emitting device of claim 1, wherein the yellow phosphor includes Lu₃Al₅O₁₂, and in the spectrum of the white light, a maximum peak wavelength, excluding the peak of blue light, ranges from 535 nm to 545 nm.

8. The white light emitting device of claim 7, wherein when a peak intensity of the blue light is 1 in the spectrum of the white light, a relative intensity at 630 nm ranges from 0.0889 to 0.2379.

9. The white light emitting device of claim 8, wherein the red phosphor is at least one of AAlSiNₓ:Eu (1≦x≦5) and A₂Si₅N₈:Eu, wherein the A is at least one of Ba, Sr, Ca, and Mg.

10. The white light emitting device of claim 8, further comprising:
a green phosphor emitting green light,
wherein, in the spectrum of the white light, when a peak intensity of the blue light is 1, a relative intensity at 490 nm ranges from 0.0831 to 0.161.

11. The white light emitting device of claim 10, wherein the green phosphor includes β-SiAlON:Eu or L₃M₅O₁₂:Ce, wherein the L is at least one of Lu, Yb, and Tb, and the M is at least one of Al and Ga.

12. A white light emitting device comprising:
a blue light emitting diode (LED) emitting blue light; and
a yellow phosphor excited by the blue light to emit yellow light consisting of La₃Si₆N₁₁,
wherein white light obtained from a mixture of the blue light and excited light corresponds to a region defined by coordinate points of (0.28, 0.28), (0.24 0.20), (0.26, 0.19), and (0.30, 0.27) in a CIE 1931 color coordinate system.

13. The white light emitting device of claim 12, wherein in a spectrum of the white light, a maximum peak wavelength, excluding the peak of blue light, ranges from 532 nm to 542 nm.

14. The white light emitting device of claim 13, further comprising a red phosphor, wherein in the spectrum of the white light, when a peak intensity of the blue light is 1, a relative intensity at 630 nm ranges from 0.0648 to 0.1913.

15. The white light emitting device of claim 14, wherein the red phosphor is at least one of AAlSiNₓ:Eu (1≦x≦5) and A₂Si₅N₈:Eu, wherein the A is at least one of Ba, Sr, Ca, and Mg.

16. The white light emitting device of claim 14, further comprising a green phosphor emitting green light, wherein in the spectrum of the white light, when a peak intensity of the blue light is 1, a relative intensity at 630 nm ranges from 0.0698 to 0.2124.

17. The white light emitting device of claim 16, wherein the green phosphor includes β-SiAlON:Eu or L₃M₅O₁₂:Ce, wherein the L is at least one of Lu, Yb, and Tb, and the M is at least one of Al and Ga.

18. The white light emitting device of claim 1, wherein a dominant wavelength band of the blue light ranges from 435 nm to 465 nm.

19. The white light emitting device of claim 12, wherein a dominant wavelength band of the blue light ranges from 435 nm to 465 nm.

20. The white light emitting device of claim 1, wherein a color gamut of the white light is 97% or more over an sRGB area.

21. The white light emitting device of claim 12, wherein a color gamut of the white light is 97% or more over an sRGB area.

22. The white light emitting device of claim 1, wherein a luminosity factor of the white light is greater than 225 lm/W.

23. The white light emitting device of claim 12, wherein a luminosity factor of the white light is greater than 225 lm/W.

24. The white light emitting device of claim 22, wherein the luminosity factor of the white light is reduced by less than 5% from a luminosity factor of the white light when the yellow phosphor is used alone.

25. The white light emitting device of claim 23, wherein the luminosity factor of the white light is reduced by less than 5% from a luminosity factor of the white light when the yellow phosphor is used alone.

26. A display apparatus comprising the white light emitting device according to claim 1.

27. A display apparatus comprising the white light emitting device according to claim 12.

28. An illumination apparatus comprising the white light emitting device according to claim 1.

29. An illumination apparatus comprising the white light emitting device according to claim 12.

30. A display apparatus comprising:
a light emitting diode (LED) light source module; and
an image display panel, to which light from the LED light source module is irradiated, displaying an image,
wherein the LED light source module includes a circuit board and at least one foregoing white light emitting device according to claim 1 mounted on the circuit board.

31. A display apparatus comprising:
a light emitting diode (LED) light source module; and
an image display panel, to which light from the LED light source module is irradiated, displaying an image,
wherein the LED light source module includes a circuit board and at least one foregoing white light emitting device according to claim 12 mounted on the circuit board.

32. An illumination apparatus comprising:
a light emitting diode (LED) light source module; and
a diffusion unit disposed above the LED light source module and uniformly diffusing light made incident from the LED light source module,
wherein the LED light source module includes a circuit board and at least one foregoing white light emitting device according to claim 1 mounted on the circuit board.

33. An illumination apparatus comprising:
a light emitting diode (LED) light source module; and
a diffusion unit disposed above the LED light source module and uniformly diffusing light made incident from the LED light source module,
wherein the LED light source module includes a circuit board and at least one foregoing white light emitting device according to claim 12 mounted on the circuit board.
